(19) United States
(12) Patent Application Publication
(10) Pub. No.: US 2010/0038491 A1
(43) Pub. Date: Feb. 18, 2010

(54) SYSTEM AND METHOD FOR TRANSFERRING CARGO CONTAINERS IN SPACE

(75) Inventors: Fank J. Cepollina, Annandale, MD (US); Mark D. Brumfield, Bowie, MD (US); Jason Budinoff, Boise, ID (US); James L. Cooper, Annapolis, MD (US); Ralph D. Green, Alexandria, VA (US)

Correspondence Address: NASA GODDARD SPACE FLIGHT CENTER, 8800 GREENBELT ROAD, MAIL CODE 140.1, GREENBELT, MD, 20771, US

(73) Assignee: U.S.A. as Represented by the Administrator of the National Aeronautics & Space Admi, Washington, DC (US)

(21) Appl. No.: 11/937,598

(22) Filed: Nov. 9, 2007

(51) Int. Cl. B64G 1/64; B64G 1/62

(52) U.S. Cl. 244/172.5

(57) ABSTRACT

Disclosed is a Host Transfer Vehicle methods and computer-readable medium for enabling the capture and berthing of passive cargo containers in space with an orbiting system, such as the International Space Station. A method embodiment positions a Host Transfer Vehicle (HTV) in proximity to an orbiting system, captures a passive cargo container launched from a ground by a grappling arm of the HTV, couples the passive cargo container to the HTV to form an HTV/cargo container stack, propels the HTV/cargo container stack within proximity of an orbiting system, and through the use of a grappling arm of the orbiting system berths the HTV/cargo container stack via a coupling structure on the cargo container to the orbiting system. The cargo container can then receive cargo from the orbiting system and either return to the ground or the cargo container can be burned up in the atmosphere.

### ORIGIN OF THE INVENTION

The invention described herein was made by employees of the United States Government and may be manufactured and used by or for the Government for governmental purposes without the payment of any royalties thereon or therefor.

### FIELD OF THE INVENTION

The present invention relates to spacecraft, and more specifically, to a system and method of manipulating and transferring cargo containers in space.

### BACKGROUND

Space travel is inherently dangerous and expensive. Transferring people and materials to and from space involves an enormous effort, cost and training. Examples of systems which require shipping humans and supplies into space include the International Space Station (ISS) and the Hubble Space Telescope (HST). The typical method of providing supplies, repairs, and people to these orbiting systems is to use the space shuttle. This approach has been used for several years. For example, the space shuttle may provide astronauts, food, scientific experiments and other necessary items to the ISS and return other astronauts, results from experiments or production to earth. In order to operate the space shuttle in such a manner as to be as safe as possible for human use, much time and expense is necessary. Using the space shuttle or other man-rated approaches to communicating with orbiting systems in some cases may be unnecessary.

Another approach is to use disposable equipment that is deployed for a particular mission and then abandoned. This can be an expensive and wasteful approach to servicing orbiting systems.

What is needed in the art is an improved system and method for transferring supplies to an orbiting system and to receive waste or results from scientific experiments and so forth from an orbiting system, such as the ISS.

### SUMMARY

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Embodiments of the present invention include systems, methods and computer-readable media for providing and operating a host transfer vehicle (HTV) in space. One embodiment is the HTV itself. The HTV utilizes a number of known systems and includes such basic features as to enable motion control in space, communication, propulsion, power control with solar panels, a compatible robotic grapple arm for the capture and manipulation of other vehicles and cargo containers as disclosed herein. A feature of this disclosure is the use of a preferably passive cargo container that is launched into space from any known launch vehicle. The cargo container is preferably launched into an orbit of, for example, 200 nautical miles, with a stable gravity gradient attitude. The HTV captures a cargo container with a grapple arm and preferably attaches the cargo container to an attachment mechanism on the HTV. The combination of the HTV and connected cargo container is an HTV/cargo container “stack”. The HTV brings the cargo container close to an orbiting system such as the ISS or Hubble Space Telescope or the like. After the HTV is cleared to approach the orbiting system, it maneuvers to a capture box where another grapple arm associated with the orbiting system grapples with the HTV/cargo container stack. If necessary, the HTV can grapple the orbiting system with its own grapple arm.

In this manner, the HTV/cargo container stack can become coupled to the orbiting system. The coupling enables the automatic or manual exchange of cargo in the cargo container with the orbiting system. Fuel may also be automatically supplied to the HTV and/or orbiting system from the cargo container. The HTV may remain connected to the cargo container until it is later needed. After supplies are removed from the cargo container, the orbiting system may return refuse, results of scientific studies, product, or any other cargo in the container. At the appropriate time, the HTV de-berths and maneuvers away from the orbiting system and engages in a de-orbit burn to place the HTV/cargo container stack into an entry trajectory. The HTV will separate from the cargo container prior to an entry interface and either enable the cargo container to burn up in the atmosphere or safely return to the ground via a parachute. Following such separation from the cargo container, the HTV can reboost back to an appropriate altitude and attitude with respect to the orbiting system.

Embodiments disclosed herein include the HTV receives and transfers a single or multiple cargo containers. Computer-readable media are also disclosed for controlling the HTV and/or other systems in order to enable the particular steps of the methods to be realized.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only exemplary embodiments of the invention and are not therefore to be considered to be limiting of its scope, the invention will be described and explained with additional specificity and detail through the use of the accompanying drawings in which:

FIG. 1 illustrates an example system embodiment;

FIG. 2 illustrates a basic Host Transfer Vehicle and its components;

FIG. 3A illustrates a process of receiving a cargo container and approaching an orbiting system;

FIG. 3B illustrates an example cargo container;

FIG. 4 illustrates an HTV/cargo container stack berthed with an orbiting system;

FIG. 5 illustrates an HTV de-berthing and separating from a cargo container;

FIG. 6 illustrates another aspect of manipulating cargo containers by the HTV further utilizing a launch vehicle;

FIG. 7 illustrates the interaction of multiple cargo containers with the HTV;

FIG. 8 illustrates a method embodiment;

FIG. 9 illustrates another method embodiment; and

FIG. 10 illustrates yet another method embodiment.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

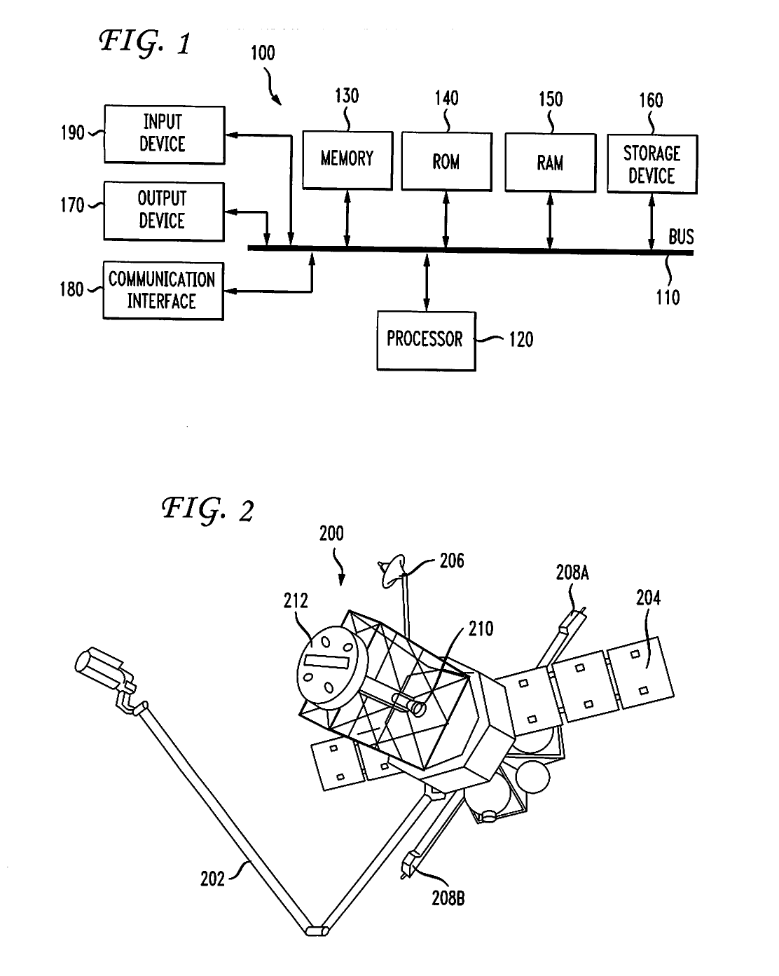

With reference to FIG. 1, an exemplary basic system for controlling components on an HTV, cargo container and/or an orbiting system and includes a general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. The system bus 110 may be any of several types of bus structures, including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive, or the like. The storage device 160 is connected to the system bus 110 by a drive interface. The drives and the associated computer readable media provide nonvolatile storage of computer readable instructions, data structures, program modules, and other data for the computing device 100. The basic components are known to those of skill in the art and appropriate variations are contemplated depending on the type of device, such as whether the device is a small, handheld computing device, a desktop computer, or a computer server.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech, and so forth. The input may, for example, be provided prior to deployment in space. The device output 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided. Individual components shown in FIG. 1 may also be tailored or modified for space as would be known in the art.

FIG. 2 illustrates the basic components of a Host Transfer Vehicle (HTV) 200. The HTV 200 utilizes several basic known systems that were developed for the modular Hubble Space Telescope de-orbit mission spacecraft. For example, basic systems include a grapple arm 202, solar panels 204 to receive energy from the sun, propulsion systems 208(A) and 208(B), a connecting or coupling structure 210 that may be used to receive a cargo container discussed below, and another coupling structure 212. Structure 212 enables the system to carry a single “in-line” cargo container on one end. This connection 212 may use a standard communication link (such as a standard crew interface) for the ISS, cargo containers, or any other orbiting system with a berthing pin arrangement and with the electrical umbilical necessary to be able to communicate necessary information between the devices. The system also includes appropriate GPS, Omni antennae 206, and propulsion or other features on booms 208(A) and (B). The robotic grapple arm 202 is used for capturing and manipulating other vehicles, cargo, cargo containers and stacks of components. The HTV 200 will make use of known heritage systems and provides a new modular maintenance friendly design that reduces development and life cycle costs.

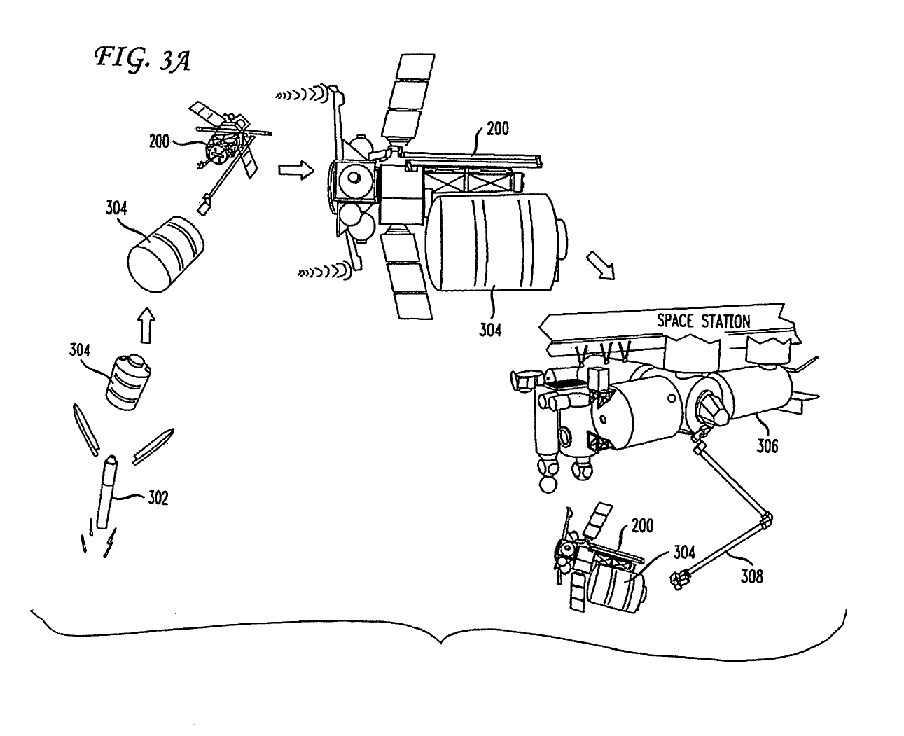

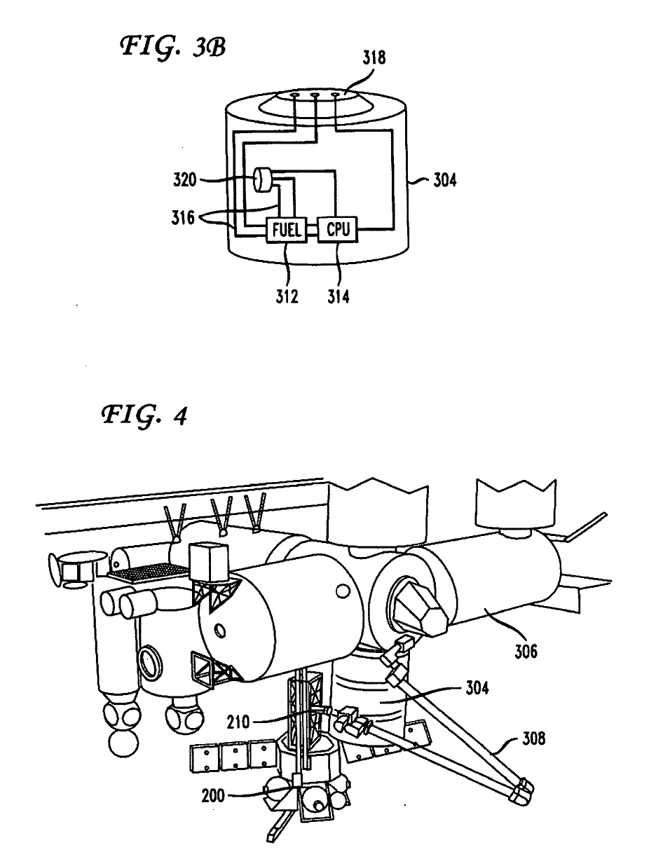

FIG. 3A illustrates an aspect of the disclosure. A cargo container 304 is launched into space from any known launch vehicle 302. The launch vehicle contains a passive cargo container 304, which is particularly designed for ease of interaction with both the HTV and an orbiting system, such as the ISS. For example, the cargo container 304 is launched into a 200 nautical mile orbit (any orbit may do) and delivered into a stable gravity gradient attitude. The HTV 200 is preferably positioned relatively near its orbiting system in order to be able to communicate cargo containers 304 to and from the orbiting system 306. The HTV 200 captures the cargo container with its grappling arm 202. Preferably, the grappling arm 202 enables the cargo container to be detachably attached to the HTV 200 via a coupling mechanism 210. The cargo container can attach on its side to mechanism 210 or on a top or bottom via coupling 212. The combination or coupling of the HTV 200 and the cargo container 304 when they are attached can be referred to as an HTV/cargo container stack. Next, the HTV/cargo container stack is maneuvered by the propulsion system of the HTV 200 into a position near the orbiting system 306. After the HTV/cargo container stack is cleared to approach the orbiting system, it maneuvers to a capture box where a grappling arm 308 associated with the orbiting system 306 grapples with and berths the HTV/cargo container stack. As an alternate method, the grappling arm 202 of the HTV 200 may grapple the orbiting system 306 in order to position the HTV/cargo container stack into position.

FIG. 3B illustrates an exemplary cargo container 304. Several features of the cargo container are discussed next. In one example embodiment, the cargo container contains fuel 312 and a central processing unit or control system 314. Shown in FIG. 3B are two fuel lines 316, which communicate with one coupling structure 320 designed with an appropriate berthing arrangement to communicate with connecting structure 210 on the HTV. Communication structure 318 is also designed with an appropriate berthing pin arrangement to be able to couple with the ISS, other orbiting system or communicate with the HTV via coupling 212. An aspect of the cargo container 309 may be for the purpose of refueling one or both of the HTV or the orbiting system. In this manner, after the grappling arm 202 establishes the HTV/cargo container stack, control system 314 may communicate data to and receive information from the HTV 200. For example, the HTV 200 may notify the cargo container 304 that it is low on fuel and needs a resupply. In this scenario, the cargo container 304 delivers a certain amount of fuel through fuel lines 316, which may then be used to replenish the fuel supply of the HTV 200. Similarly, battery systems (not shown) can be utilized in the cargo container 304 to operate the control system 314. Electrical power drawn from the solar panels of the HTV and stored in batteries on the HTV can enable, if necessary, a replenishing of battery power in the cargo container 304. In this manner, the cargo container 304 can be used for additional purposes besides simply carrying cargo to and from an orbiting system.

FIG. 4 illustrates the connection of the HTV/cargo container stack with the orbiting system 306. Once the grappling arm 308 has positioned the HTV/cargo container stack into the appropriate position, it can be berthed at a node 2 Common Berthing Mechanism (CBM). In this communicating structure, an opening in the cargo container 304 will communicate in a manner which may be known to those of skill in the art with the orbiting system 306 such that cargo in the cargo container can be transferred to the orbiting system 306. As noted above, fuel and information can also be communicated to/from the stack. For example, fuel can be delivered from the orbiting system, to the fuel container 312 in the cargo container, and to the HTV 200 via couplings 320/210.

In this position, the HTV 200 can remain connected to the cargo container 304 via the connection mechanism 210 until the cargo container 304 can be filled with results from scientific studies, refuse, product, or until another resupply is scheduled.

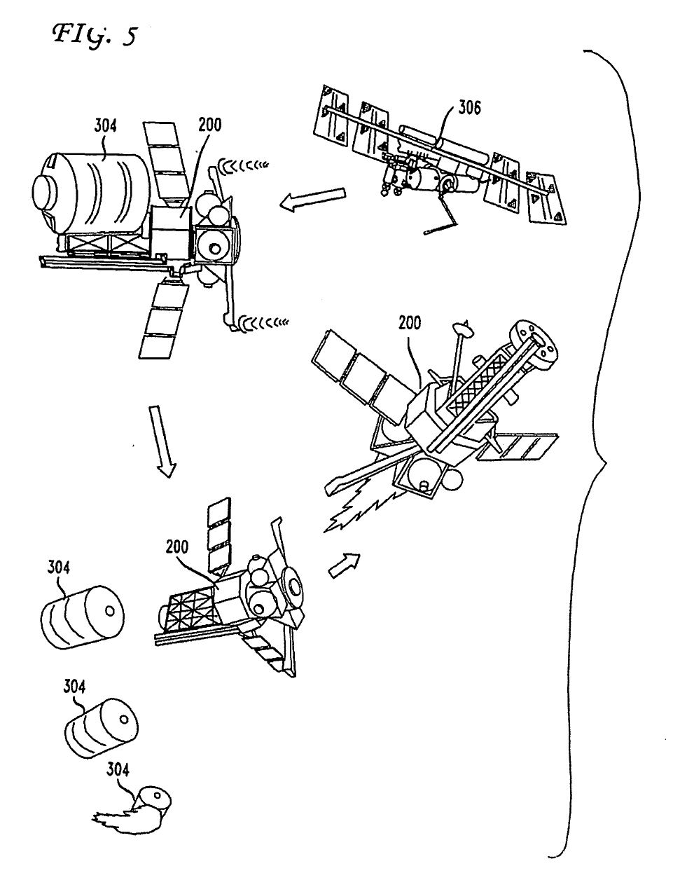

FIG. 5 illustrates the mechanism of de-berthing and returning the cargo container either to ground or to be burned up in space. In this case, the method begins with receiving refuse, the results of scientific studies, product, or nothing into the cargo container 304 while it is berthed at the orbiting system 306. The HTV 200 de-berths and maneuvers away from the orbiting system 306 and engages in a de-orbit burn to place the HTV/cargo container stack into an entry trajectory. The entry trajectory is positioned in such a manner as when the HTV 200 separates from the cargo container 304 prior to an entry interface, the cargo container 304 can be positioned to either burn up in an atmosphere or be positioned to safely return to ground via parachute. In this aspect, either automatically or via a manual interruption, the cargo container is either burned up or returned to ground based on its cargo, i.e., burned, if cargo is refuse, or returned to ground, if it is product (and perhaps some refuse). After this function, the HTV 200 will re-boost back into an appropriate altitude and proximity to the orbiting system 306 that it services.

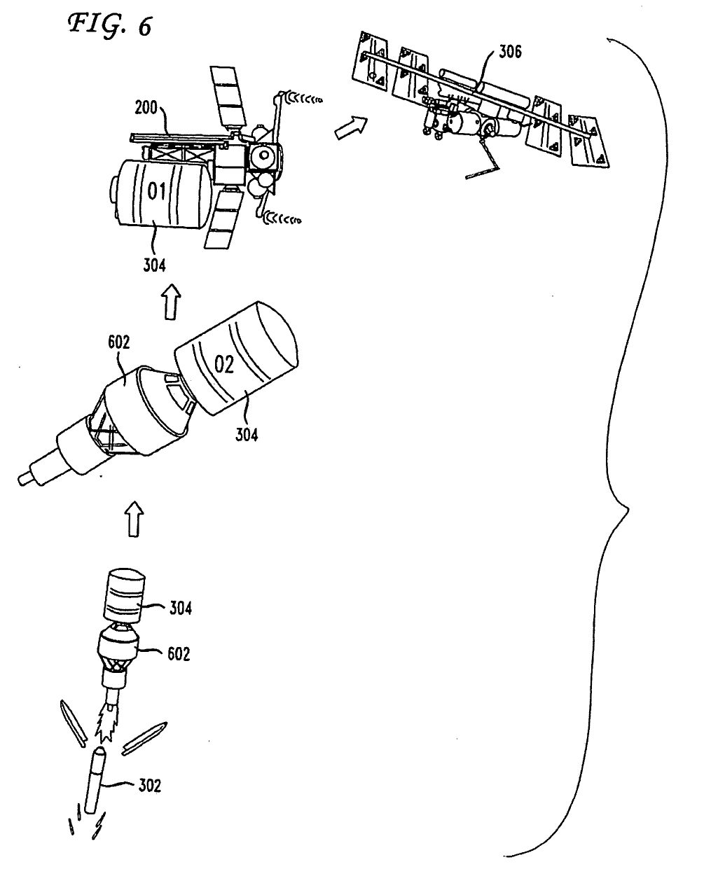

FIG. 6 illustrates another aspect of the disclosure. In this case, a cargo container 304 is launched into an orbit from any launch vehicle 302. An additional second stage launch vehicle 602 injects the cargo container 304 into an appropriate orbit associated with the orbiting system 306. The cargo container 304 does not separate from the launch vehicle second stage 602 after circulization. The cargo container/second stage launch vehicle stack remains in orbit. In this configuration, the HTV 200 may manipulate two or more cargo containers 304 at the same time. As is shown in FIG. 6, a cargo container 01 (cargo containers 304 are labeled as “01” for the old container and “02” for the new container) is already connected to the HTV 200. In this example, the HTV 200 has received a refuse cargo container 01 from the orbiting system 306 and is ready to receive a new cargo container 02/second stage stack. The HTV 200 brings cargo container 01 filled with refuse for disposal or items for safe return to the ground. In this case, the HTV 200 must exchange the old cargo container 01 with the new cargo container 02 associated with the cargo container/launch vehicle second stage stack.

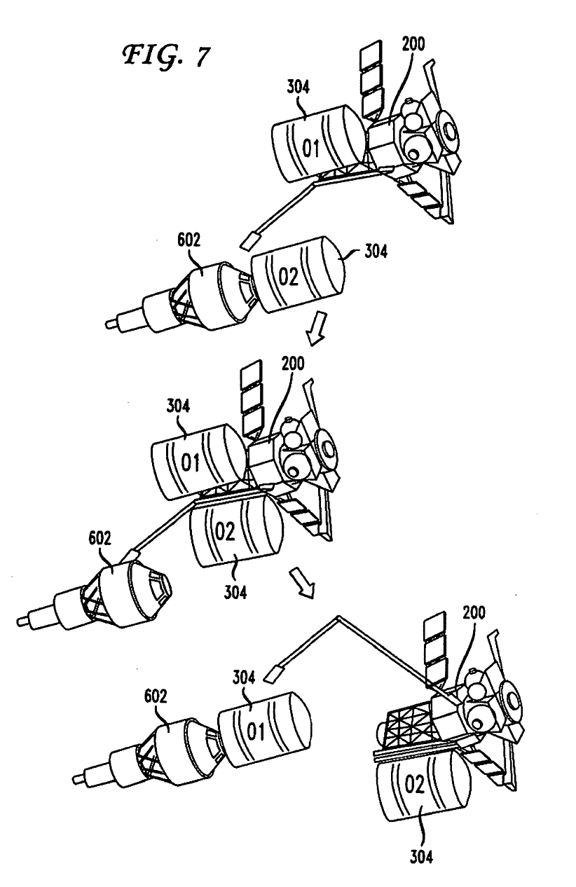

FIG. 7 illustrates how this is done. The HTV 200 with the old cargo container 01 grapples with and docks with the new cargo container 02 and the second stage launch vehicle. Once cargo container 02 is connected with the HTV 200, the grapple arm removes the second stage launch vehicle from cargo container 02 and reattaches the second stage launch vehicle to cargo container 01. The HTV 200 with cargo container 02 then detaches from the cargo container 01 and second stage launch vehicle stack. In this manner, the second stage launch vehicle can then return cargo container 01 safely to earth or proceed to position cargo container 01 into an entry trajectory for burning up in the atmosphere or returning to earth. HTV 200 then can take the new cargo container 02 and, in a manner similar as discussed above, maneuver cargo container 02 into position to engage and couple with the orbiting system 306.

A benefit to the disclosed approach is that the cargo containers 304 may be passive and develop from maximum simplicity and cost. For example, the lack of any need for any propulsion system enables simple deployment, capture, and interaction with an orbiting system through the use of the HTV 200. Such cargo containers may be built to be reusable and thus may be used in many contexts. In addition to the HTV 200 being deployed for manipulating, capturing, and transferring passive cargo containers, the abilities of the system can also enable assembly, packing, and unpacking of complex satellite systems and any other necessary uses of vehicle with such important features.

With the availability of HTVs 200, the possibility of orbital supply depots becomes available. Cargo items, such as food, water, and propulsion modules, can be launched using these cargo containers 304. They do not need to contain any expensive systems or on board rendezvous and capture sensors. The HTV 200 can retrieve such items and bring them to an orbiting supply depot, which can receive a plurality of cargo containers 304 of different types, which can be stored as required. As an example, the HTV 200 can move a new water container from a simple truss stowage system over to a man-rated node for resupply of a Crew Exploration Vehicle (CEV). An example supply depot can be a structure that can both receive and stow cargo items as well as enable the HTV 200 to attach at multiple locations along a supply depot structure to give it a solid base from which to operate with its grapple arm to manipulate and move various simple passive cargo containers. The HTV 200 carries, as noted above, basic avionic sub-systems, such as a guidance, navigation and control (GNAC) panel, power panel, battery panel, communications panel, electronics panel, a grappling arm, a high gain antenna system (HGAS), a sensory suite, avionics modules, solar arrays, batteries, reaction wheels, torque rods, fuels, and thrusters.

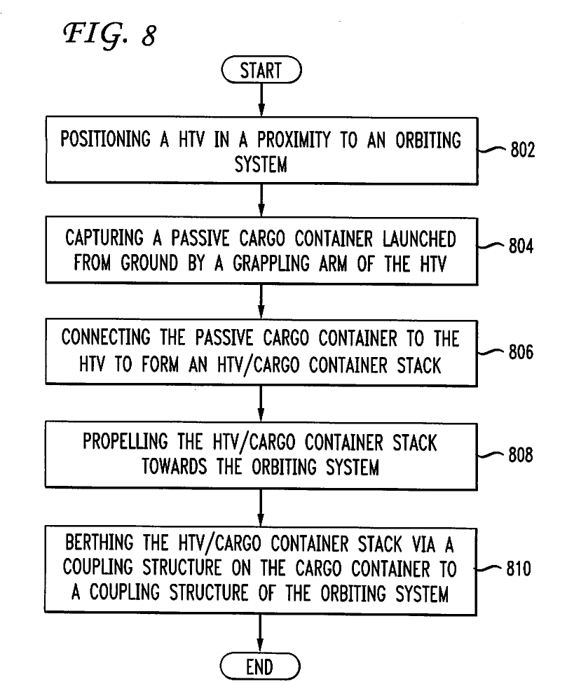

There are several method embodiments of the invention which cover several scenarios of retrieving and delivering passive cargo containers to and from an orbiting system. FIG. 8 illustrates an example method embodiment which illustrates a method of interacting with an orbiting system using a HTV. The method includes positioning a HTV in a proximity to an orbiting system (802). This positioning can be at an appropriate distance from the orbiting system that may depend on the type of orbiting system. For example, the ISS can have a preferred safe proximity of, for example, 10 nautical miles, whereas a HST may have a different proximity that is appropriate. Next, the HTV captures a passive cargo container launched from ground by a grappling arm of the HTV (804) and connects the passive cargo container to the HTV to form an HTV/cargo container stack (806). The connecting or coupling of the passive cargo container to the HTV can be performed on a coupling unit on a side of the cargo container stack or on a bottom or top coupling structure. The HTV is configured in a flexible manner such that multiple cargo container stacks may be coupled and manipulated to the HTV on its side, top, and bottom. Next, the HTV propels the HTV/cargo container stack towards the orbiting system (810). As the HTV/cargo container stack comes into an appropriate proximity to the orbiting system, preferably a grappling arm of the orbiting system will grapple the HTV/cargo container stack and move it into position for berthing the HTV/cargo container stack via a coupling structure on the cargo container to a coupling structure of the orbiting system (812).

Other aspects of this method may involve sensing, via a connection between the HTV and the passive control container, to determine whether the HTV needs fuel. If so, the method can involve transferring fuel from the passive cargo container to the HTV. In this regard, it is preferable that the passive cargo container include a fuel cell and a controlling system, which will receive information regarding the fuel levels of the HTV and control, via mechanisms known to those of skill in the art, the flow of fuel from a fuel container with the passive cargo container through a coupling to the HTV. The fuel container in the passive cargo container can also be used to refuel the orbiting system while the passive cargo container is berthed through use of the coupling mechanism, which can be used to communicate information to and from the cargo container and orbiting system as well as fuel.

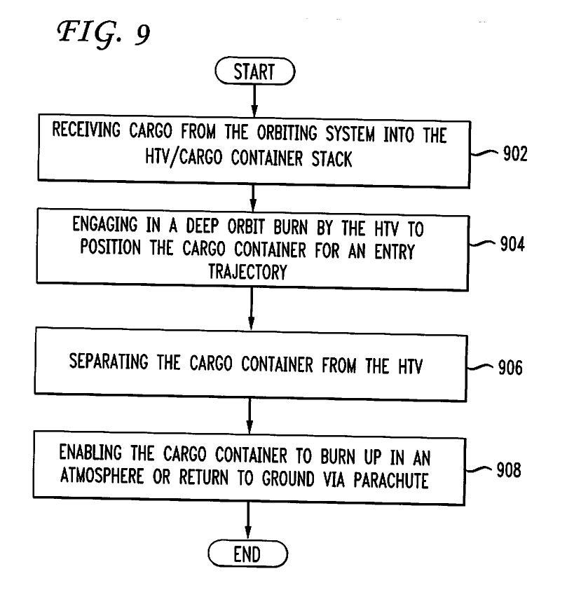

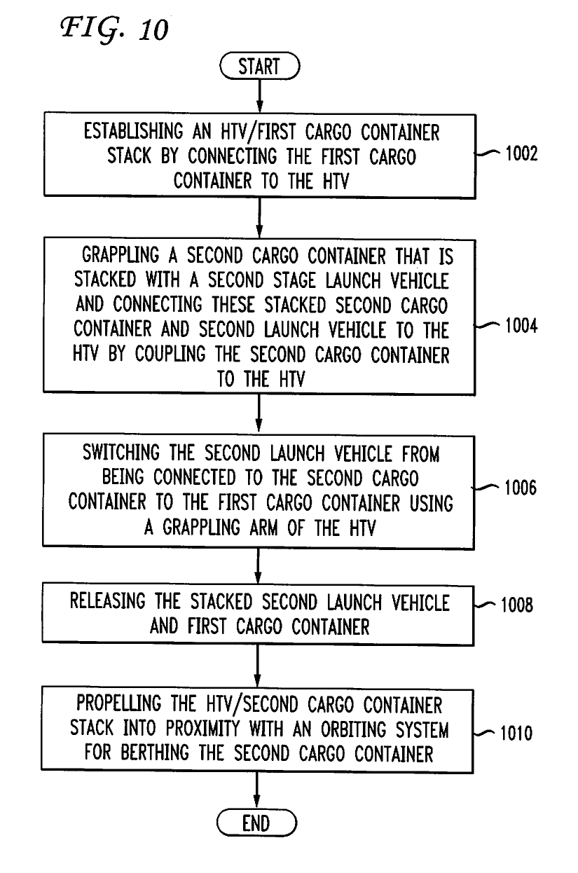

FIG. 9 illustrates a method of interacting with an orbiting system where in the HTV/cargo container stack is berthed with the orbiting system to begin. This embodiment provides for receiving cargo, if any, from the orbiting system into the HTV/cargo container stack (902), engaging in a deep orbit burn by the HTV to position the cargo container for an entry trajectory (904), separating the cargo container from the HTV (906), and enabling the cargo container to burn up in an atmosphere or return to ground via parachute (910). This method can also involve separating the HTV/cargo container stack from the orbiting system, receiving at the HTV a second cargo container/second launch vehicle stack. This is preferably done via a grappling arm in the HTV that engages a second cargo container that is stacked with a second launch vehicle and attaching the second cargo container to a coupling on the HTV. At this point, the HTV has coupled to it a first cargo container and a second cargo container/second launch vehicle stack. Next, the method can involve switching the second launch vehicle from the second cargo container to the cargo container using an HTV grappling arm and separating the cargo container from the HTV further includes separating the cargo container/second launch vehicle stack from the HTV. This approach enables the cargo container to burn up or return to ground from the HTV using the second launch vehicle that was deployed to propel into orbit the second cargo container. The second launch vehicle can then be used to either propel the (first) cargo container into a trajectory to burn it up in space or to return it to ground.

FIG. 10 illustrates yet another embodiment of the invention that deals with interacting with the Host Transfer system when interacting with multiple cargo containers. In this aspect, the method provides for establishing an HTV/first cargo container stack by connecting the first cargo container to the HTV (1002), grappling a second cargo container that is stacked with a second stage launch vehicle and connecting these stacked second cargo container and second launch vehicle to the HTV by coupling the second cargo container to the HTV (1004), switching the second launch vehicle from being connected to the second cargo container to the first cargo container using a grappling arm of the HTV (1006), releasing the stacked second launch vehicle and first cargo container (1008), and propelling the HTV/second cargo container stack into proximity with an orbiting system for berthing the second cargo container (1010).

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can include RAM, ROM, EEPROM, CD-ROM or other optical disk storage, magnetic disk storage, or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps. Program modules may also comprise any tangible computer-readable medium in connection with the various hardware computer components disclosed herein, when operating to perform a particular function based on the instructions of the program contained in the medium.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Although the above description may contain specific details, they should not be construed as limiting the claims in any way. Other configurations of the described embodiments of the invention are part of the scope of this invention. For example, the concepts disclosed herein may apply to earth (when “ground” is referred to) or any other planet or moon. Accordingly, the appended claims and their legal equivalents should only define the invention, rather than any specific examples given.

I claim:

1. A method of interacting with an orbiting system, the method comprising:
positioning a Host Transfer Vehicle (HTV) in a proximity to an orbiting system;
capturing a passive cargo container launched from ground by a grappling arm of the HTV;
connecting the passive cargo container to the HTV to form an HTV/cargo container stack;
propelling the HTV/cargo container stack towards the orbiting system; and
berthing the HTV/cargo container stack via a coupling structure on the cargo container to the orbiting system.

2. The method of claim 1, further comprising:
sensing via a connection between the HTV and the passive cargo container whether the HTV needs fuel; and
transferring fuel from the passive cargo container to the HTV if the fuel is needed.

3. The method of claim 1, wherein the passive cargo container further comprises fuel and a controlling system.

4. The method of claim 1, further comprising:
refueling the orbiting system with fuel from the passive cargo container, while the passive cargo container is berthed.

5. A method of interacting with a Host Transfer Vehicle (HTV), the method comprising:
establishing an HTV/first cargo container stack by connecting the first cargo container to the HTV;
grappling a second cargo container that is stacked with a second stage launch vehicle and connecting the stacked second cargo container and second stage launch vehicle to the HTV by coupling the second cargo container to the HTV;
switching the second launch vehicle from being connected to the second cargo container to the first cargo container using a grappling arm on the HTV;
releasing the stacked second launch vehicle and first cargo container; and
propelling the HTV/second cargo container stack into proximity to an orbiting system for berthing the second cargo container.

6. The method of claim 5, further comprising:
de-orbiting the second launch vehicle/first cargo container stack.

7. The method of claim 5, further comprising:
refueling the HTV as the second cargo container is connected to the HTV.

8. The method of claim 5, wherein the first cargo container and second cargo container are passive.

9. The method of claim 5, wherein the HTV is further configured to connect more than two cargo containers.

10. A method of interacting with an orbiting system, wherein a Host Transfer Vehicle (HTV)/cargo container stack is berthed with the orbiting system via a structure that connects the cargo container to the orbiting system in a manner to enable exchange of cargo between the cargo container and the orbiting system; the method comprising:
receiving cargo, if any, from the orbiting system into a HTV/cargo container stack;
engaging in a deep orbit burn by the HTV to position the cargo container for an entry trajectory;
separating the cargo container from the HTV; and
enabling the cargo container to burn up in an atmosphere or return to ground via parachute.

11. The method of claim 10, wherein the cargo container is passive.

12. The method of claim 10, further comprising:
separating the HTV/cargo container stack from the orbiting system;
receiving at the HTV a second cargo container/second launch vehicle stack; and
switching the second launch vehicle from the second cargo container to the cargo container using a HTV grappling arm, wherein separating the cargo container from the HTV further comprises separating the cargo container/second launch vehicle stack from the HTV.

13. The method of claim 12, wherein enabling the cargo container to burn up or to return to ground further comprises using the second launch vehicle to enable the cargo container to either burn up or return to ground.

14. A Host Transfer Vehicle (HTV) deployed in space, the HTV comprising:
control and communication systems;
propulsion systems;
a grappling arm; and
at least one coupling mechanism, wherein the control and communication systems and propulsion system are configured to:
control a position and application of the grappling arm to grapple and couple passive cargo containers delivered into proximity of the HTV by a launch vehicle; and
maneuver the cargo container within proximity of an orbiting system such that a grappling arm of the orbiting system can berth the cargo container to a berthing coupling on the orbiting system.

15. The host transfer vehicle of claim 14, wherein the control and communication systems and propulsion system are further configured to:
release the HTV/cargo container stack from berthing with the orbiting system;
propel the HTV/cargo container stack from the orbiting system and position the cargo container for an entry trajectory; and
release the cargo container to enable the cargo container to either burn up in an atmosphere or return to ground via parachute.

16. The host transfer vehicle of claim 14, wherein the cargo container is passive.

17. The host transfer vehicle of claim 14, wherein the control system is further configured to cause a transfer of fuel from the cargo container to the HTV when the cargo container is coupled to the HTV.

18. The host transfer vehicle of claim 14, wherein the control system is further configured to control a receipt of fuel from the orbiting system to the cargo container for docking to the HTV.
